(19) United States
(12) Patent Application Publication
(10) Pub. No.: US 2003/0102365 A1
(43) Pub. Date: Jun. 5, 2003

(54) Personal data carrier, passport provided with the facial image, and method of and system for verifying identity of individual carrying the passport

(76) Inventor: David Elderfield, Calgary Alberta (CA)

Correspondence Address: ILYA ZBOROVSKY, 6 Schoolhouse Way, Dix Hills, NY, 11746, US

(21) Appl. No.: 09/996,886

(22) Filed: Nov. 30, 2001

(51) Int. Cl. G06F 17/00

(52) U.S. Cl. 235/375

(57) ABSTRACT

For verifying an identity of an individual a passport is provided with a facial image of an individual, and a code which corresponds to a fingerprint of the same individual, the image and the fingerprint of the individual with the code are sent and stored in a secure database; and thereafter when the passport is presented to an official, a fingerprint of the presenter is taken and sent to the database with the code, and from the computer system a conclusion is obtained whether the taken fingerprint corresponds to the fingerprint stored in the database.

### BACKGROUND OF THE INVENTION

The present invention relates to a personal data carrier, a passport provided with a facial image, and a method of and system for verifying an identity of an individual carrying the passport.

It is known to make passport photos which include an image of an individual, so that when the passport is later used, a corresponding official can verify that a person who gives them a passport is the real owner of the passport. It is also known to provide additionally fingerprints of a user, to improve the identification of a passport carrier. Also some systems are known which analyze the corresponding data of a passport user to verify whether a person who gives a passport to an official is a real owner of the passport. Such solutions are disclosed for example in U.S. Pat. Nos. 3,694,240; 5,760,386; 5,509,083; 6,146,777; 6,263,090; 6,269,169. It is believed that the existing solutions can be further improved.

### SUMMARY OF THE INVENTION

Accordingly, it is an object of present invention to provide a personal data carrier, a passport provided with a facial image, and a method of and system for a verifying an individual carrying the passport, which are further improvements of existing solutions.

In keeping with these objects and with others which will become apparent hereinafter, one feature of the present invention resides, briefly stated, in a personal data carrier having a substrate with two opposite sides, a photo image of an individual provided on one of the sides of the substrate, a fingerprint of the same individual provided on the opposite side of the substrate, such that the image and the fingerprint with a code can be stored in a secure database, and thereafter an official to whom a passport is presented, can take a fingerprint of a presenter, send it to the database with the code, and obtain from the database a conclusion whether the taken fingerprint corresponds to the fingerprint stored in the database.

Another feature of the present invention resides in a passport which is provided with a photo image of an individual, and a code which corresponds to a fingerprint of the same individual, such that the image and the fingerprint together with the code can be stored in a database, and thereafter an official to whom the passport is presented can take a fingerprint, or a portion thereof, of a presenter, send it to the database with the code, and obtain from the database a conclusion whether the taken fingerprint corresponds to the fingerprint stored in the database.

Still a further feature of the present invention resides in a method of verifying an identity of an individual, which includes the steps of providing a passport having a facial image of an individual, and a code which corresponds to a fingerprint of the same individual; transmitting the image and the fingerprint of the individual with the code to and storing the same in a secure database; and checking the database to ensure the fingerprint is unique to the database; and thereafter when the passport is presented to an official, taking a fingerprint of the presenter, sending it, or a portion thereof, to the secure database with the code, and obtaining from the database a conclusion whether the taken fingerprint corresponds to the fingerprint stored in the computer system.

Finally, it is still a further feature of the present invention to provide a system which has a passport with a facial image of an individual and with a code corresponding to a fingerprint of the same individual; a secure database which can store the image and the fingerprint of the individual with the code, the database being formed so that when an official who is presented with the passport takes a fingerprint of the presenter and sends it, or a portion thereof, to the database with the code, the database can compare the taken fingerprint with the fingerprint stored in the database and make a conclusion whether it may correspond to one another or not.

When a personal data carrier, a passport and a method of and system for verifying an identity of an individual carrying the passport are designed in accordance with the present invention, they constitute a further improvement of the existing solutions in this area.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1 and 2 are a front view and a rear view of an image carrier in accordance with the present invention;

FIG. 3 is a perspective view of a passport in accordance with the present invention;

FIG. 4 is a view schematically illustrating an inventive method of and system for verifying an individual carrying the passport;

FIG. 5 is a view of a scanning/printing device which is used in the inventive method and system; and

FIG. 6 is a view showing a portable data communicator with built-in scanner, which an official can use to obtain a fingerprint of a passport holder.

### DESCRIPTION OF THE PREFERRED EMBODIMENTS

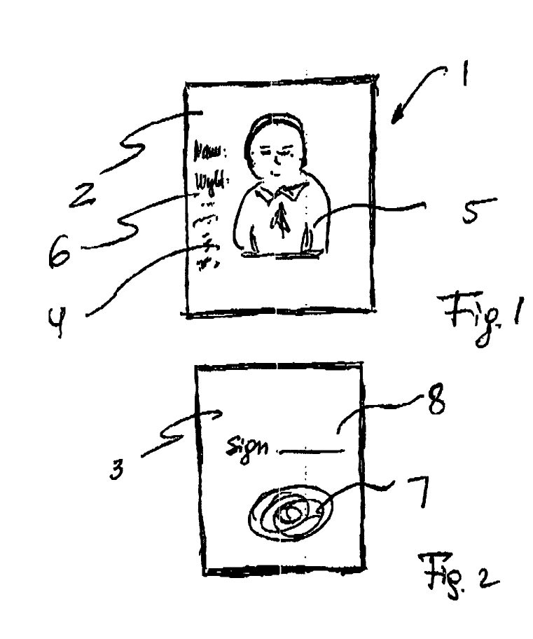

In accordance with the present invention a personal data carrier is provided as shown in FIGS. 1 and 2. The personal data carrier can be formed as a photograph which includes a substrate 1 formed from a corresponding material, for example paper, plastic, etc. and having a front side 2 and a rear side 3. The front side 2 of the substrate 1 is provided with an image which is identified with reference numeral 4. The image 4 can include a photo image of a part of a user, for example of his face as identified with reference numeral 5.

As shown in FIG. 2, the opposite side 3 of the substrate 1 is provided with a fingerprint of the user which can be obtained by well known processes. Also, the user can sign the photograph in an area identified with reference numeral 8. Thus, the image carrier formed as a photograph has the user's image 4, possibly with additional data on the front side 2, and the fingerprint 7 on the opposite side, possibly with a signature and other data on the rear side.

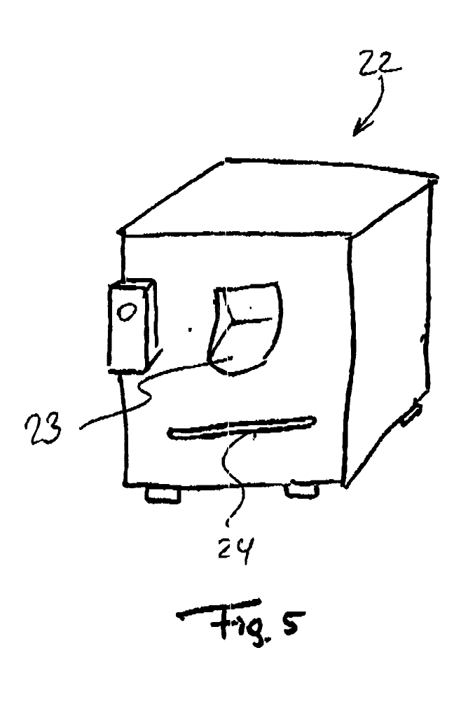

The fingerprint data is scaled and oriented in the scanner/printer device shown in FIG. 5 so that this data is always presented in the same manner. Likewise the printer/scanner device can be equipped with an electronic signature pad so that the applicant's signature is also oriented and sized properly on the rear of image carrier

In order to make such a personal data carrier, the photograph can be made in a conventional way, and then inserted into the device shown in FIG. 5. The customer places his finger in the device, and the device will print on the opposite side, the fingerprint image.

The photograph along with the known passport application form is sent to the known government authorities for passport applications. The photograph and fingerprint are scanned into a secure database and the record is given a unique identifier, such as a code, for example a barcode.

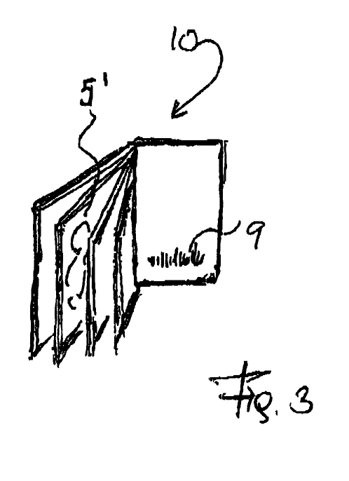

FIG. 3 identifies a passport of the user. It includes an imprinted facial image 5′ and a code 9 formed for example as a barcode with a unique sequence. It is understood that other codes can be used. While the facial image 5′ can be formed in one part of the passport identified as a whole with reference numeral 10, the code 9 can be provided in another part of the passport 10. In particular the facial image 5′ can be formed provided on a first page of the passport 10, while the code 9 can be provided on a last page of the passport 10.

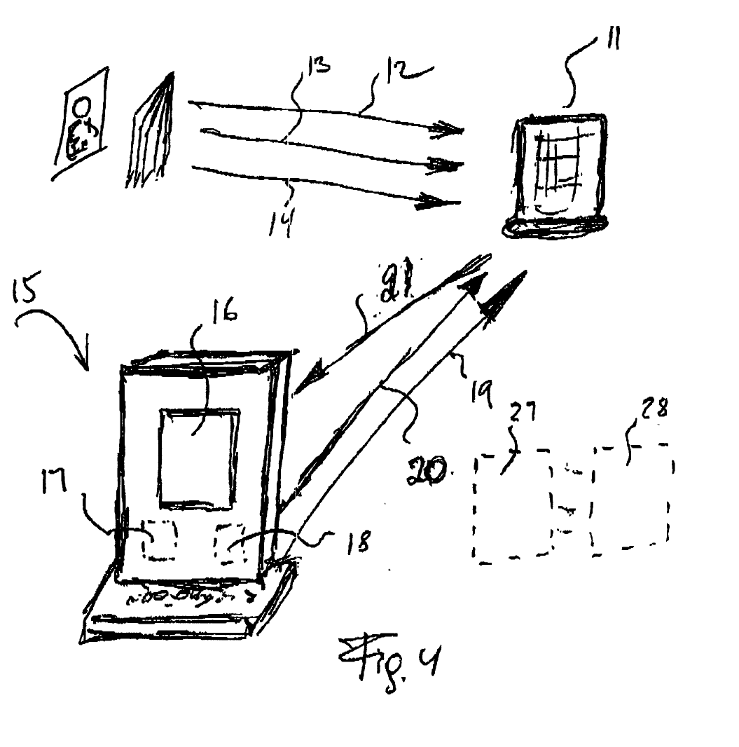

The above mentioned data related to the user are sent to a secure computer database system 11 and inputted and stored there as shown in FIG. 4. In particular, the image 4 of the user is sent and inputted as identified with reference numeral 12 to the database 11, the fingerprint 7 is send and inputted as identified with reference numeral 13 to the database 11, and the code 9 is created and inputted into the database 11 as identified with reference numeral 14. The thusly sent and created data are stored in the database system 11. The passport is produced from the individual's database file obtained, for example, by an official, who imprints the facial image and code on the passport.

An official to who a passport is presented compares the presenter with the image in the passport and with the corresponding image downloaded from the database and displayed on the official's monitor 15. If the official has suspicions and is willing to check the identity of the presenter more thoroughly, he uses a scanner/display device which is identified as a whole with reference numeral 15. The device 15 has a display 16, a code reader 17, and a fingerprint reader 18 and an encrypted access to read data from the secure database. The official introduces the portion of the passport 10 with the bar code 9 into the code reader 17 and sends the data about the bar code to the secure database 11 as identified with reference numeral 19. The secure database then returns the image of the photo being stored and displays it on the display 16, so that the official can compare the obtained facial image with the facial image in the passport and of the face of the passport presenter. Should the official have any doubts as to the validity of the passport or the identity of the passport presenter, the official will ask the presenter to put his finger in the fingerprint reader 18, and the fingerprint reader 18 transmits the data of the fingerprint, or a portion thereof, to the secure database 11 as identified with reference numeral 20. The database 11, based on the received code, compares the fingerprint stored in it with the fingerprint taken by the official and sent to the computer system. The database 11 then sends to the official or more particularly to the device 15 the conclusion whether the fingerprints match or miss match as identified with reference numeral 21.

FIG. 5 identifies a scanning/printing device 22 which has a fingerprint scanning area 23 and a personal data carrier (photographs) slot 24 for introducing the photograph and printing the fingerprint image on its opposite side, as explained above.

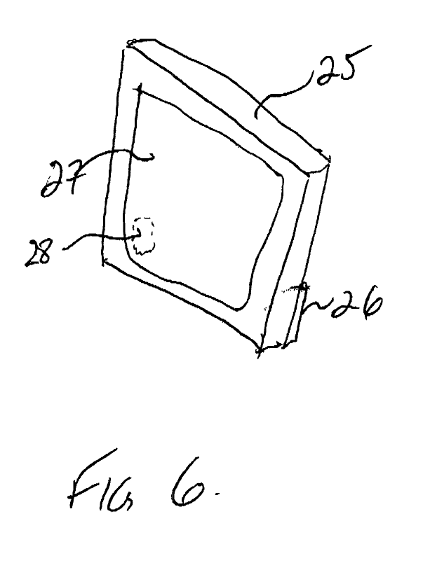

FIG. 6 shows a portable scanner 25 which an official can use when he is checking a passport. The scanner 25 has an area 26 which can be contacted by a finger of a passport holder, so that an image of the fingerprint can be transmitted to the database 11 and compared with the fingerprint image stored in the database 11. The device 25 has a display 27, a code reader 28, an encrypted access to read data from the secure database. The display 27 will provide a facial image of the passport holder from the secure database for comparison purposes.

The scanner/printer device 22, the scanner/display device 15 and the scanner/display device 25 are provided with an antibacterial additive during the manufacture as they will be contacted by many different persons.

In the inventive system the fingerprint is not shown in a digital format nor is digitally stored anywhere in the system, outside the secure computer system 11.

In addition to the fingerprints, the inventive system can use further identifiers. For example, the image 4 can be formed in a different way. The image 4 on the data carrier or in the passport can include two photographs, one frontal and one profile. An applicant for the passport goes to a studio, has the two different photo views taken, endorses them with a fingerprint, and sends them with an application for obtaining a passport. The two photo views are transmitted to the database 11, so that a three-dimensional image is produced and stored in the system. A video camera can be installed for use by officials, for example at an airport gate, at the border, etc. as identified with reference numeral 27 in FIG. 4. The video camera 27 produces a three-dimensional image of a passport presenter and sends it to the database 11, which compares the transmitted three-dimensional image with the stored three-dimensional features and informs the official whether they match or mismatch.

Another identifier can be retinal data of a user. When a person presents the passport he is asked to make a retinal scan by a retinal scanner 28 which transmits the thusly obtained retinal image to the database 11 for storing the retinal image. Thereafter, at a later time when an official wants to identify a user of a passport, the retinal scanner 28 makes a retinal scan of the passport presenter's eyes, transmits it the database 11, and the database 11 compares the received retinal image and the stored retinal image to determine whether they match or mismatch.

Still another identifier can be DNA data of a user. It will operate in the same way as above mentioned identifiers. A person will be asked to make a DNA test and its results will be compared with the data stored in the secure database.

It is to be understood that other identifiers can be used as well.

It is believed to be clear that the inventive system and method provide a completely reliable identification of an individual who presents a passport to an official.

The inventive system can be also used for identification of animals, for example those transported across the borders, etc. Naturally, instead of fingerprints other identifiers will be used for example special marks, hoof prints, etc. Rather than a passport and bar code the animal may carry a tattoo or transducer.

It will be understood that each of the elements described above, or two or more together, may also find a useful application in other types of constructions differing from the types described above.

While the invention has been illustrated and described as embodied in image carrier, passport provided with the image carrier and a method of and system for a verifying an individual carrying the passport, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A personal data carrier, comprising a substrate with two opposite sides, a photo image of an individual provided on one of the sides of the substrate, a fingerprint of the same individual provided on the opposite side of the substrate, such that the image and the fingerprint with a code can be stored in a secure database, and thereafter an official to whom a passport is presented can take a fingerprint of a presenter, send it to the database with the code, and obtain from the database a conclusion whether the taken fingerprint corresponds to the fingerprint stored in the database.

2. A passport, comprising a facial image of an individual, and a code which corresponds to a database file containing a fingerprint of the same individual, such that the image and the fingerprint together with the code can be stored in a database, and thereafter an official to whom a passport is presented can take a fingerprint of a presenter, send it to the database with the code, and obtain from the database a conclusion whether the taken fingerprint corresponds to the fingerprint stored in the database.

3. A passport as defined in claim 2, wherein said passport has at least two parts, said photo image being provided on one of said parts, while said code being provided on another of said parts.

4. A passport as defined in claim 2, wherein said code is formed as a barcode with a unique sequence.

5. A method of verifying an identity of an individual, comprising the steps of providing a passport with a facial image of an individual, and a code which corresponds to a database containing a fingerprint of the same individual; transmitting the fingerprint of the individual with the code to and storing the same in a secure database; and thereafter when the passport is presented to an official, taking a fingerprint of the presenter, sending it to the database with the code, and obtaining from the database a conclusion whether the taken fingerprint corresponds to the fingerprint stored in the database.

6. A method as defined in claim 5; and further comprising transmitting a retinal image of a user to be stored in the database; making a retinal image of a user when he presents a passport; and sending the made retinal image to the database; and comparing by the data base whether the retinal images match or mismatch.

7. A method as defined in claim 5; and further comprising the step of making the photo image by photographing a frontal and a profile of the user and transmitting the same to the database so as to form and store a three-dimensional image; during verification taking a three-dimensional image of a user who presents the passport and submitting it to the database; and comparing the three-dimensional images by the database to determine whether they match or mismatch.

8. A system, comprising a passport with a facial image of an individual and a code corresponding to a database file containing a fingerprint of the same individual; a secure database receiving and storing the image and the fingerprint of the individual with the code, said database being formed so that when an official who is presented with the passport takes a fingerprint of the presenter and sends it to the database with the code, the database compares the taken fingerprint with the fingerprint stored in the database and makes a conclusion whether the fingerprints match or mismatch.

9. A system as defined in claim 8; and further comprising means for transmitting a retinal image of a user to be stored in the database; means for making a retinal image of a user when he presents a passport and sending the made retinal image to the database; said database comparing the retinal images with one another and making a conclusion whether the retinal images match or mismatch.

10. A system as defined in claim 8; and further comprising means for making the photo image by photographing a frontal and a profile of the user such that the image can be stored to the database so as to form and store a three-dimensional image; means for taking a three-dimensional image of a user who presents the passport during verification and submitting it to the database; and means for comparing the three-dimensional images by the database to determine whether they match or mismatch.

11. A system for verifying a passport comprising a database in which a facial image and a fingerprint of a passport owner together with a code is stored; and means by which an official enters the code so as to display on a monitor the facial image stored in said database and to compare the displayed facial image with a facial image in the passport, said database being operative for comparing the fingerprint stored in the database with the fingerprint of the passport owner to verify that a database file containing the facial image is correct.
